(19) United States
(12) Patent Application Publication
(10) Pub. No.: US 2023/0127998 A1
(43) Pub. Date: Apr. 27, 2023

(54) AMMONIA ENGINE

(71) Applicant: MITSUBISHI HEAVY INDUSTRIES, LTD., Tokyo (JP)

(72) Inventors: Yusuke IMAMORI, Tokyo (JP); Masafumi MORI, Tokyo (JP); Naoyuki MORI, Tokyo (JP)

(73) Assignee: MITSUBISHI HEAVY INDUSTRIES, LTD., Tokyo (JP)

(21) Appl. No.: 17/908,762

(22) PCT Filed: Feb. 16, 2021
(86) PCT No.: PCT/JP2021/005654

§ 371 Date: Sep. 1, 2022

(30) Foreign Application Priority Data
Mar. 6, 2020 (JP) 2020-039001

(51) Int. Cl. F02M 21/02; F02M 26/42; F02D 19/02

(52) U.S. Cl. CPC F02M 21/0206; F02D 19/023; F02M 26/42

(57) ABSTRACT

An ammonia engine includes: an engine body which includes a first cylinder and a second cylinder; an air supply unit which supplies air to each of the first cylinder and the second cylinder; an ammonia supply unit which supplies ammonia to each of the first cylinder and the second cylinder; an ammonia amount adjustment unit which adjusts an ammonia supply amount to the second cylinder by the ammonia supply unit to be larger than an ammonia supply amount to the first cylinder; and an exhaust gas supply unit which supplies an exhaust gas generated by the second cylinder to the first cylinder.

### TECHNICAL FIELD

The present disclosure relates to an ammonia engine.

Priority is claimed on Japanese Patent Application No. 2020-039001, filed Mar. 6, 2020, the content of which is incorporated herein by reference.

### BACKGROUND ART

Research and development on engines (ammonia engines) that use ammonia as fuel are being widely conducted for the purpose of reducing CO₂ and effectively utilizing excess energy (for example, see Patent Document 1 below). Here, it is known that a misfire occurs under a low to medium load if the fuel is 100% ammonia in an ammonia engine based on an existing gasoline engine. Therefore, a technology for converting a part of ammonia into hydrogen by using a catalyst device including a cracking reactor is proposed. Accordingly, it is said that the combustion speed and ignitability are improved and stable operation can be realized.

### RELATED ART DOCUMENTS

### Patent Document

Patent Document 1

Japanese Unexamined Patent Application, First Publication No. 2012-255420

### SUMMARY OF INVENTION

### Problem to Be Solved by the Invention

However, if the above-described catalyst device is provided, there is a concern about increase in cost and decrease in the maintainability due to the deterioration of the catalyst itself. Further, since it is necessary to use a part of the fuel to raise the catalyst temperature in order to promote the catalytic reaction, there is a possibility that the thermal efficiency may decrease.

The present disclosure is made to solve the above-described problems and an object thereof is to provide an ammonia engine which can be efficiently operated in a wider operation range.

### Means for Solving the Problem

In order to solve the above-described problems, an ammonia engine according to the present disclosure includes: an engine body which includes a first cylinder and a second cylinder; an air supply unit which supplies air to each of the first cylinder and the second cylinder; an ammonia supply unit which supplies ammonia to each of the first cylinder and the second cylinder; an ammonia amount adjustment unit which adjusts an ammonia supply amount to the second cylinder by the ammonia supply unit to be larger than an ammonia supply amount to the first cylinder; and an exhaust gas supply unit which supplies an exhaust gas generated by the second cylinder to the first cylinder.

### Effect of the Invention

According to the present disclosure, it is possible to provide an ammonia engine which can be efficiently operated in a wider operation range.

### BRIEF DESCRIPTION OF THE DRAWINGS

FIG. 1 is a schematic diagram showing a configuration of an ammonia engine according to a first embodiment of the present disclosure.

FIG. 2 is a schematic diagram showing a configuration of an ammonia engine according to a second embodiment of the present disclosure.

FIG. 3 is a schematic diagram showing a configuration of an engine body according to a third embodiment of the present disclosure.

### EMBODIMENTS FOR CARRYING OUT THE INVENTION

### First Embodiment

### Configuration of Ammonia Engine

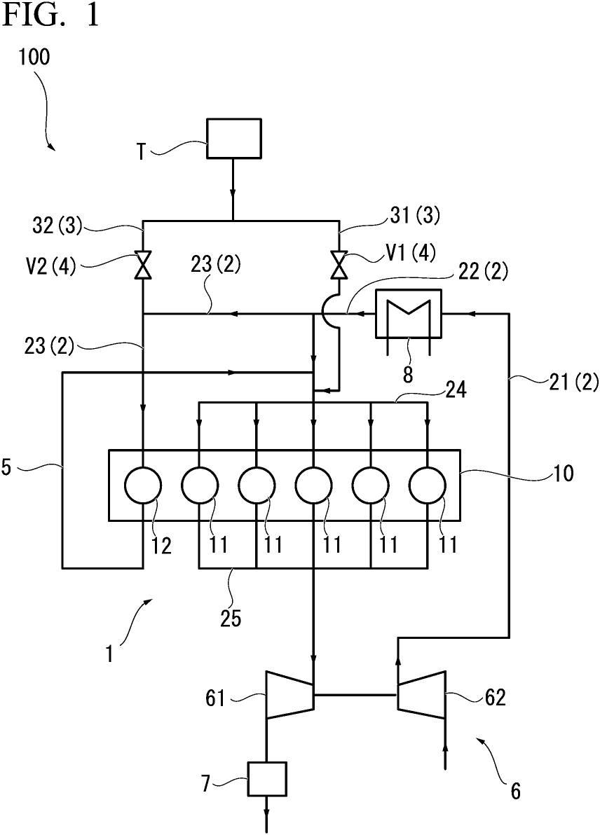

Hereinafter, an ammonia engine 100 according to a first embodiment of the present disclosure is described with reference to FIG. 1. As shown in the same drawing, the ammonia engine 100 includes an engine body 1, an air supply unit 2, an ammonia supply unit 3, an ammonia amount adjustment unit 4, an exhaust gas supply unit 5, a turbo charger 6, a catalyst device 7, an air cooler 8, and an ammonia supply source T. The ammonia engine 100 is used as a drive source for vehicles or the like by mixing air with ammonia supplied from the ammonia supply source T and burning the mixture in the engine body 1.

### Configuration of Engine Body

The engine body 1 includes a cylinder block 10, a first cylinder 11, and a second cylinder 12. The cylinder block 10 accommodates pistons of the first cylinder 11 and the second cylinder 12. These pistons move forward and backward in the cylinder block 10. As described in detail later, the ratio (fuel-air ratio) of the supplied fuel (ammonia) and air is different between the first cylinder 11 and the second cylinder 12. Further, the compression ratio of the second cylinder 12 is set to be higher than the compression ratio of the first cylinder 11. As an example, the compression ratio of the first cylinder 11 is set to 10 to 15 and the compression ratio of the second cylinder 12 is set to about 30. In the example of FIG. 1, the engine body 1 includes five first cylinders 11 and one second cylinder 12.

### Configurations of Turbo Charger and Air Supply Unit

The air supply unit 2 supplies air taken from the outside through the turbo charger 6 to each of the first cylinder 11 and the second cylinder 12 of the engine body 1. The turbo charger 6 includes a turbine 61 and a compressor 62. The turbine 61 is rotationally driven by an exhaust gas of the engine body 1. The turbine 61 is connected to an exhaust line 25 (to be described later) guiding an exhaust gas generated by the engine body 1. The compressor 62 is coaxially connected to the turbine 61. The compressor 62 is rotationally driven in accordance with the rotation of the turbine 61 so that external air is compressed to generate high-pressure air. This high-pressure air is supplied to the engine body 1 through the air supply unit 2.

The air supply unit 2 includes a first air line 21, a second air line 22, a third air line 23, an intake line 24, and an exhaust line 25. One end of the first air line 21 is connected to the discharge side of the compressor 62. The air cooler 8 is connected to the other end of the first air line 21. High-temperature air guided from the compressor 62 through the first air line 21 is cooled by passing through the air cooler 8. The air cooler 8 is a heat exchanger which cools air by exchanging heat between the air and the refrigerant supplied from the outside.

One end of the second air line 22 is connected to the downstream side of the air cooler 8. The other end of the second air line 22 is connected to the intake line 24. The intake line 24 distributes the air guided from the second air line 22 toward five first cylinders 11. Further, the exhaust gas which is generated by each first cylinder 11 is supplied to the turbine 61 through the exhaust line 25. The catalyst device 7 is connected to the discharge side of the turbine 61. By passing through the catalyst device 7, the denitrated and oxidized exhaust gas is discharged to the outside.

The third air line 23 connects the downstream side of the air cooler 8 to the second cylinder 12.

### Configuration of Ammonia Supply Unit

The ammonia supply unit 3 supplies ammonia to each of the first cylinder 11 and the second cylinder 12. The ammonia supply unit 3 includes a first ammonia line 31 and a second ammonia line 32. The first ammonia line 31 connects the ammonia supply source T to the second air line 22. The second ammonia line 32 connects the ammonia supply source T to the third air line 23. That is, a mixture of air and ammonia is supplied to the first cylinder 11 and the second cylinder 12 through the second air line 22 and the third air line 23. Although not shown in detail, it is preferable to adjust the position and the shape of the nozzle that supplies ammonia so that ammonia, air, and a mixture thereof are layered (stratified) in the second cylinder 12. Accordingly, since the mixture that is in a flammable range of ammonia is locally present, it is possible to ignite even if the ammonia supply amount is excessive.

### Configuration of Ammonia Amount Adjustment Unit

The ammonia amount adjustment unit 4 adjusts the ammonia supply amount by the ammonia supply unit 3. The ammonia amount adjustment unit 4 includes a first valve V1 which is provided on the first ammonia line 31 and a second valve V2 which is provided on the second ammonia line 32. It is preferable that the first valve V1 and the second valve V2 are flow control valves capable of changing the flow rate of ammonia by adjusting their respective opening degrees. The opening degree of the second valve V2 is set to be larger than the opening degree of the first valve V1. That is, the ammonia amount adjustment unit 4 adjusts the ammonia supply amount per each cylinder to the second cylinder 12 to be larger than the ammonia supply amount per each cylinder to the first cylinder 11. Accordingly, in the second cylinder 12, a fuel-rich (ammonia-rich) combustion cycle occurs as compared with in the first cylinder 11. More specifically, ammonia is supplied to be equal to or smaller than the equivalent ratio in the first cylinder 11 and ammonia is supplied to exceed the equivalent ratio in the second cylinder 12. Additionally, it is more preferable that the equivalent ratio of the first cylinder 11 is 1. In this case, a relatively inexpensive three-way catalyst can be used for the flow passage of the exhaust gas, and as a result, the NOx emission amount can be reduced.

### Configuration of Exhaust Gas Supply Unit

The exhaust gas line 5 (exhaust gas supply unit) connects the second cylinder 12 to a position of the second air line 22 on the side closer to the air cooler 8 than the other end of the first ammonia line 31. An exhaust gas generated by the second cylinder 12 is supplied to the first cylinder 11 through the exhaust gas line 5. Here, as described above, ammonia is supplied to the second cylinder 12 to exceed the equivalent ratio. Therefore, an unburned ammonia component is generated in the second cylinder 12. This unburned component is converted to hydrogen by the heat of the engine body 1. That is, this hydrogen is contained in the exhaust gas supplied to the first cylinder 11 through the exhaust gas line 5.

### Operation and Effect

It is known that a misfire occurs under a low to medium load if the fuel is 100% ammonia in an ammonia engine based on a gasoline engine. Therefore, a technology for converting a part of ammonia into hydrogen by using a cracking reactor are proposed. Accordingly, it is said that the combustion speed and ignitability are improved and stable operation can be realized.

However, when the above-described cracking reactor is actively used, there is a concern about increase in cost and decrease in the maintainability due to the deterioration of the catalyst itself. Further, since it is necessary to use a part of the fuel to raise the catalyst temperature in order to promote the catalytic reaction, there is a possibility that the thermal efficiency may decrease.

Here, in the ammonia engine 100 according to this embodiment, the ammonia supply amount to the second cylinder 12 is set to be larger than the ammonia supply amount to the first cylinder 11. Accordingly, excess ammonia remains as an unburned component in the second cylinder 12. This excess ammonia is converted into hydrogen due to the heat of the engine body 1. That is, hydrogen is contained in an exhaust gas generated in the second cylinder 12. By supplying this exhaust gas to the first cylinder 11 through the exhaust gas line 5, a mixture of ammonia and hydrogen can be used as fuel in the first cylinder 11. Accordingly, the above-described cracking reactor can be omitted or the processing capacity required for the cracking reactor can be kept small. As a result, it is possible to efficiently operate the ammonia engine 100 in a wider operation range.

Further, according to the above-described configuration, since the ammonia supply amount to the second cylinder 12 is an amount exceeding the equivalent ratio, an unburned ammonia component can be stably generated. Accordingly, the exhaust gas supplied to the first cylinder 11 can be in a state where hydrogen is normally contained. As a result, it is possible to more stably operate the ammonia engine 100.

In addition, according to the above-described configuration, since the compression ratio of the second cylinder 12 is high, ammonia can be spontaneously ignited by compression like a diesel engine. Accordingly, for example, auxiliary equipment such as ignition plugs may not be used, the number of ignition plugs may be reduced, or performance requirements may be relaxed. As a result, it is possible to improve the reliability and maintainability of the ammonia engine 100.

### Second Embodiment

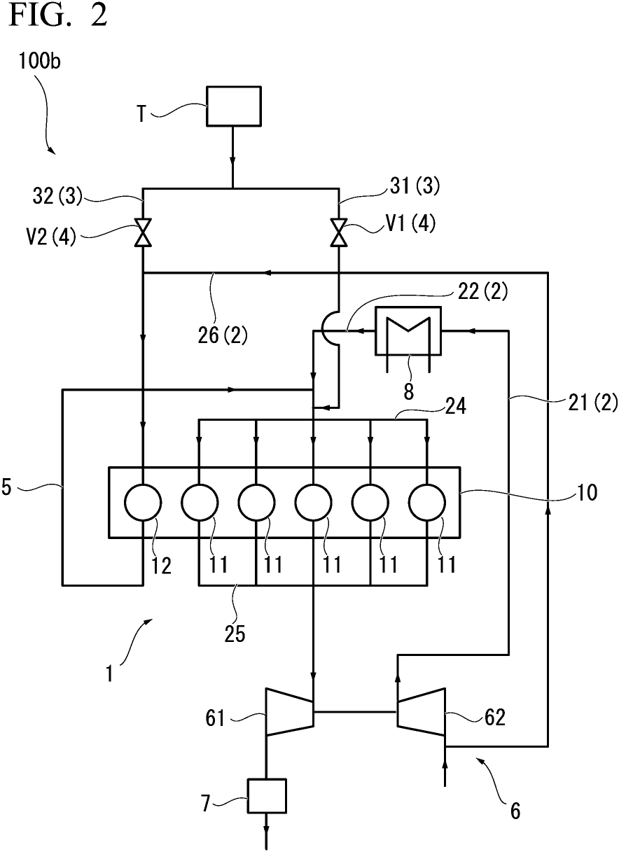

Next, an ammonia engine 100b according to a second embodiment of the present disclosure is described with reference to FIG. 2. Additionally, the same components as those of the first embodiment are designated by the same reference numerals, and detailed description thereof is omitted. In the ammonia engine 100b, the configuration of an air supply unit 2b is different from that of the first embodiment. The air supply unit 2b does not include the above-described third air line 23 and includes an atmospheric pressure line 26. The atmospheric pressure line 26 branches from the intake side of the compressor 62 and is connected to the second cylinder 12. Through this atmospheric pressure line 26, air is guided to the second cylinder 12 without passing through the turbo charger 6.

According to the above-described configuration, atmospheric pressure air is supplied to the second cylinder 12 through the atmospheric pressure line 26. In the second cylinder 12, a mixture of ammonia and air is burned due to spontaneous ignition by compression. In this way, since the second cylinder 12 burs ammonia using atmospheric pressure air, the maximum pressure of the second cylinder 12 can be suppressed to a low level. Accordingly, it is possible to further improve the reliability of the ammonia engine 100b.

### Third Embodiment

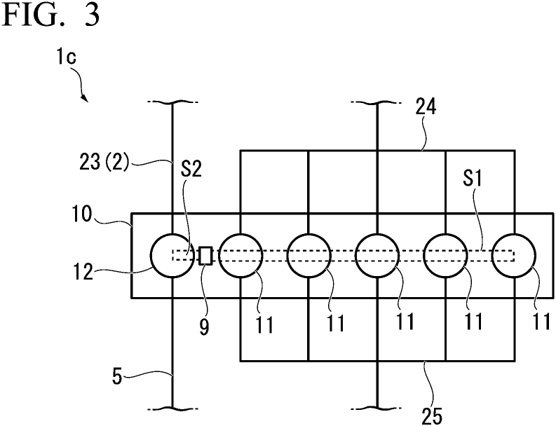

Next, a third embodiment of the present disclosure is described with reference to FIG. 3. Additionally, the same components as those of the above-described embodiments are designated by the same reference numerals, and detailed description thereof is omitted. As shown in the same drawing, an engine body 1c according to this embodiment further includes a first crank shaft S1 which drives the first cylinder 11, a second crank shaft S2 which drives the second cylinder 12, and a speed reducer 9 which is provided between the first crank shaft S1 and the second crank shaft S2. The speed reduction ratio of the speed reducer 9 is set so that the second crank shaft S2 rotates at a lower speed than the first crank shaft S1.

According to the above-described configuration, the speed reducer 9 is provided between the first crank shaft S1 and the second crank shaft S2 and the second crank shaft S2 rotates at a lower speed than the first crank shaft S1. Accordingly, the second cylinder 12 has a slower combustion cycle than the first cylinder 11. Therefore, it is possible to ensure a long residence time of the gas generated by the combustion in the second cylinder 12. As a result, it is possible to more stably promote a change from excess ammonia generated in the second cylinder 12 to hydrogen. Thus, it is possible to more stably and efficiently operate the engine body 1c.

### Other Embodiments

The embodiments of the present disclosure are described above. Additionally, various changes and modifications can be made to the above-described configuration without departing from the scope of the present disclosure. For example, in the above-described embodiments, examples are described in which only hydrogen based on excess ammonia generated by the second cylinder 12 is supplied to the first cylinder 11. However, the ammonia supply source of hydrogen is not limited thereto, and for example, a cracking reactor may be used in combination to supply the hydrogen generated by the cracking reactor to the first cylinder 11. Further, in the above-described embodiments, an example is described in which the engine body 1 includes five first cylinders 11 and one second cylinder 12. However, the number of the first cylinder 11 and the second cylinder 12 can be appropriately changed according to the design and specifications.

### Appendix

The ammonia engine 100 described in each embodiment is grasped as follows, for example.

(1) The ammonia engine 100 according to a first aspect includes: the engine body 1 which includes the first cylinder 11 and the second cylinder 12; the air supply unit 2 which supplies air to each of the first cylinder 11 and the second cylinder 12; the ammonia supply unit 3 which supplies ammonia to each of the first cylinder 11 and the second cylinder 12; the ammonia amount adjustment unit 4 which adjusts the ammonia supply amount per each cylinder to the second cylinder 12 by the ammonia supply unit 3 to be larger than the ammonia supply amount per each cylinder to the first cylinder 11; and the exhaust gas supply unit 5 which supplies an exhaust gas generated by the second cylinder 12 to the first cylinder 11.

According to the above-described configuration, since the ammonia supply amount to the second cylinder 12 is larger than the ammonia supply amount to the first cylinder 11, excess ammonia remains as an unburned component in the second cylinder 12. This excess ammonia is converted into hydrogen by the heat of the engine body 1. When the exhaust gas supply unit 5 supplies the exhaust gas to the first cylinder 11, a mixture of ammonia and hydrogen can be used as fuel in the first cylinder 11.

(2) In the ammonia engine 100 according to a second aspect, the ammonia amount adjustment unit 4 adjusts the ammonia supply amount per each cylinder to the second cylinder 12 to be an amount exceeding the equivalent ratio and adjusts the ammonia supply amount per each cylinder to the first cylinder 11 to be an amount equal to or smaller than the equivalent ratio.

According to the above-described configuration, since the ammonia supply amount to the second cylinder 12 is an amount exceeding the equivalent ratio, it is possible to stably generate an unburned ammonia component.

(3) In the ammonia engine 100 according to a third aspect, the compression ratio of the second cylinder 12 is set to be higher than the compression ratio of the first cylinder 11.

According to the above-described configuration, since the compression ratio of the second cylinder 12 is high, ammonia can be spontaneously ignited by compression.

(4) In the ammonia engine 100 according to a fourth aspect, the air supply unit 2 is configured to supply atmospheric pressure air to the second cylinder 12.

According to the above-described configuration, since the second cylinder 12 burns ammonia by using atmospheric pressure air, the maximum pressure of the second cylinder 12 can be suppressed to a low level.

(5) In the ammonia engine 100 according to a fifth aspect, the engine body 1c includes the first crank shaft S1 which drives the first cylinder 11, the second crank shaft S2 which drives the second cylinder 12, and the speed reducer 9 which is provided between the first crank shaft S1 and the second crank shaft S2 and the second crank shaft S2 is configured to rotate at a lower speed than the first crank shaft S1.

According to the above-described configuration, the second crank shaft S2 rotates at a lower speed than the first crank shaft S1. Accordingly, the second cylinder 12 has a slower combustion cycle than the first cylinder 11. Therefore, it is possible to more stably promote a change from excess ammonia generated in the second cylinder 12 to hydrogen.

(6) In the ammonia engine 100 according to a sixth aspect, in the second cylinder 12, the position and the shape of the nozzle that supplies ammonia are set so that ammonia, air, and a mixture thereof are layered.

According to the above-described configuration, since the mixture that is in a flammable range of ammonia is locally present, it is possible to ignite even if the ammonia supply amount is excessive.

(7) In the ammonia engine 100 according to a seventh aspect, the equivalent ratio of ammonia to air in the second cylinder 12 is 1.

According to the above-described configuration, a relatively inexpensive three-way catalyst can be used for the flow passage of the exhaust gas, and as a result, the NOx emission amount can be reduced.

(8) In the ammonia engine 100 according to an eighth aspect, the compression ratio of the second cylinder 12 is set to be higher than the compression ratio at which ammonia spontaneously ignites.

According to the above-described configuration, ammonia can be spontaneously ignited by compression. Accordingly, for example, auxiliary equipment such as ignition plugs may not be used, the number of ignition plugs may be reduced, or performance requirements may be relaxed. As a result, it is possible to improve the reliability and maintainability of the ammonia engine 100.

### INDUSTRIAL APPLICABILITY

According to the present disclosure, it is possible to provide an ammonia engine which can be efficiently operated in a wider operation range.

### Reference Symbols

100, 100b Ammonia engine
1, 1c Engine body
2 Air supply unit
3 Ammonia supply unit
4 Ammonia amount adjustment unit
5 Exhaust gas line (exhaust gas supply unit)
6 Turbo charger
7 Catalyst device
8 Air cooler
9 Speed reducer
10 Cylinder block
11 First cylinder
12 Second cylinder
21 First air line
22 Second air line
23 Third air line
24 Intake line
25 Exhaust line
31 First ammonia line
32 Second ammonia line
61 Turbine
62 Compressor
S1 First crank shaft
S2 Second crank shaft
T Ammonia supply source
V1 First valve
V2 Second valve

1. An ammonia engine comprising:
an engine body which includes a first cylinder and a second cylinder;
an air supply unit which supplies air to each of the first cylinder and the second cylinder;
an ammonia supply unit which supplies ammonia to each of the first cylinder and the second cylinder;
an ammonia amount adjustment unit which adjusts an ammonia supply amount per each cylinder to the second cylinder by the ammonia supply unit to be larger than an ammonia supply amount per each cylinder to the first cylinder; and
an exhaust gas supply unit which supplies an exhaust gas generated by the second cylinder to the first cylinder,
wherein the air supply unit is configured to supply atmospheric pressure air to the second cylinder.

2. The ammonia engine according to claim 1,
wherein the ammonia amount adjustment unit adjusts the ammonia supply amount per each cylinder to the second cylinder to be an amount exceeding an equivalent ratio and adjusts the ammonia supply amount per each cylinder to the first cylinder to be an amount equal to or smaller than the equivalent ratio.

3. The ammonia engine according to claim 1,
wherein a compression ratio of the second cylinder is set to be higher than a compression ratio of the first cylinder.

4. (canceled)

5. The ammonia engine according to claim 1,
wherein the engine body includes a first crank shaft which drives the first cylinder, a second crank shaft which drives the second cylinder, and a speed reducer which is provided between the first crank shaft and the second crank shaft, and
wherein the second crank shaft is configured to rotate at a lower speed than the first crank shaft.

6. The ammonia engine according to claim 1,
wherein in the second cylinder, a position and a shape of a nozzle that supplies ammonia are set so that ammonia, air, and a mixture thereof are layered.

7. The ammonia engine according to claim 1,
wherein the equivalent ratio of ammonia to air in the second cylinder is 1.

8. The ammonia engine according to claim 1,
wherein a compression ratio of the second cylinder is set to be higher than a compression ratio at which ammonia spontaneously ignites.
